(19) United States
(12) Patent Application Publication
(10) Pub. No.: US 2025/0036049 A1
(43) Pub. Date: Jan. 30, 2025

(54) FIXING DEVICE AND IMAGE FORMING APPARATUS

(71) Applicant: FUJIFILM Business Innovation Corp., Tokyo (JP)

(72) Inventors: Takayuki UKAWA, Kanagawa (JP); Hideki KUGE, Kanagawa (JP); Yoshiki SHIMODAIRA, Kanagawa (JP); Masato YAMASHITA, Kanagawa (JP); Yutaka KIUCHI, Kanagawa (JP); Takayuki YAMASHITA, Kanagawa (JP)

(21) Appl. No.: 18/597,273

(22) Filed: Mar. 6, 2024

(30) Foreign Application Priority Data
Jul. 26, 2023 (JP) 2023-121677

(51) Int. Cl. G03G 15/20

(52) U.S. Cl. CPC G03G 15/2025; G03G 15/2064

(57) ABSTRACT

A fixing device includes: a heating roll that heats a recording medium having a toner image formed on the recording medium while rotating in contact with the recording medium; a pressure roll that sandwiches the recording medium with the heating roll to pressurize the recording medium; a first cleaning section that removes toner adhering to the heating roll; and a second cleaning section that is located downstream of the first cleaning section in a rotation direction of the heating roll and removes wax adhering to the heating roll.

### CROSS-REFERENCE TO RELATED APPLICATIONS

This application is based on and claims priority under 35 USC 119 from Japanese Patent Application No. 2023-121677 filed Jul. 26, 2023.

### BACKGROUND

### (i) Technical Field

The present invention relates to a fixing device and an image forming apparatus.

### (ii) Related Art

In an image forming apparatus using an electrophotographic method, after a toner image is formed on a surface of a recording medium such as a sheet, the toner image on the recording medium is fixed onto the recording medium by a fixing device. The fixing device sandwiches the recording medium with, for example, a heating roll and a pressure roll, and heats and pressurizes toner to melt the toner and fix the toner onto the recording medium. In this fixing step, a part of the toner forming the toner image peels off from the recording medium and adheres to the heating roll. Therefore, it is necessary to remove the toner adhering to the heating roll.

JP2007-183682A discloses a configuration in which a web is fed while being in contact with a heating roll to clean a surface of a heating roll.

### SUMMARY

Not only toner particles but also wax contained in toner adhere to the heating roll, and therefore, when the heating roll is cleaned, it is also required to remove the wax.

Aspects of non-limiting embodiments of the present disclosure relate to a fixing device and an image forming apparatus capable of removing wax contained in toner as compared with a configuration in which a cleaning unit for removing toner from a heating roll is provided.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a fixing device comprising:
a heating roll that heats a recording medium having a toner image formed on the recording medium while rotating in contact with the recording medium;
a pressure roll that sandwiches the recording medium with the heating roll to pressurize the recording medium;
a first cleaning section that removes toner adhering to the heating roll; and
a second cleaning section that is located downstream of the first cleaning section in a rotation direction of the heating roll and removes wax adhering to the heating roll.

### BRIEF DESCRIPTION OF THE DRAWINGS

Exemplary embodiments of the present invention will be described in detail based on the following figures, wherein:

FIG. 1 is a diagram for describing an image forming apparatus to which the present exemplary embodiment is applied;

FIG. 2 is a diagram schematically illustrating a configuration of a fixer;

FIG. 3 is a diagram illustrating an example of a configuration of a first cleaning section and a second cleaning section;

FIG. 4 is a diagram illustrating another example of the configuration of the fixer;

FIG. 5 is a diagram illustrating a modification of the fixer illustrated in FIG. 4; and

FIG. 6 is a diagram illustrating another example of the configuration of the fixer having an external heating device.

### DETAILED DESCRIPTION

Hereinafter, exemplary embodiments of the present invention will be described in detail with reference to the accompanying drawings.

### <Configuration of Image Forming Apparatus>

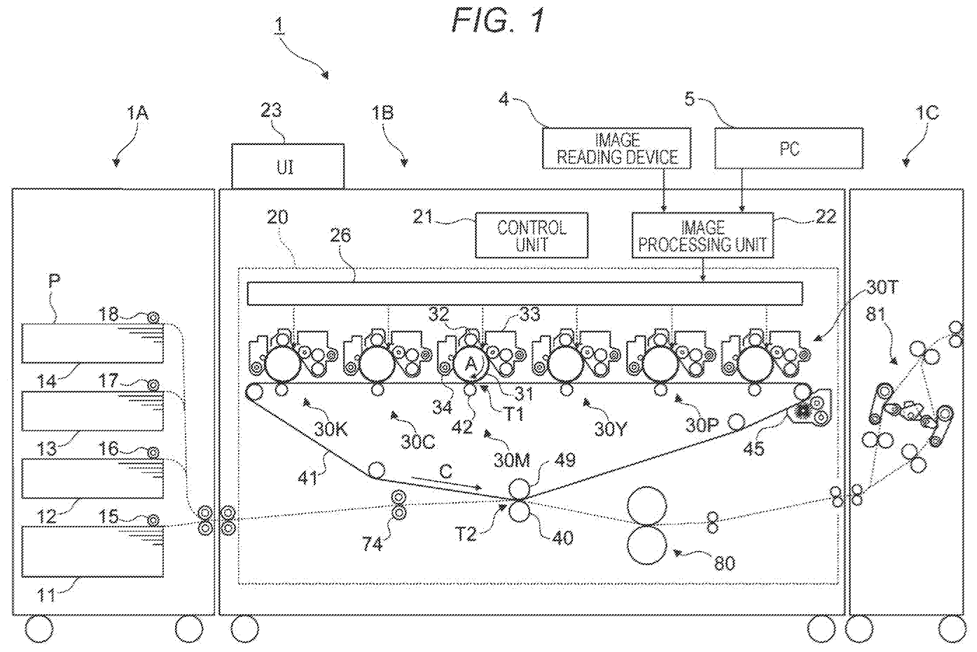

FIG. 1 is a diagram illustrating an image forming apparatus 1 to which the present exemplary embodiment is applied. The image forming apparatus 1 according to the present exemplary embodiment includes a sheet feeding unit 1A, an image forming unit 1B, and a sheet discharge unit 1C. The sheet feeding unit 1A includes first to fourth sheet storage portions 11 to 14 that store sheets P as examples of a recording medium. The sheet feeding unit 1A is also provided with feed rolls 15 to 18 that are provided corresponding to the first to fourth sheet storage portions 11 to 14, respectively, and that feed the sheets P stored in the sheet storage portions to a conveyance path connected to the image forming unit 1B.

The image forming unit 1B includes an image forming section 20 that forms an image on a sheet P. In addition, the image forming unit 1B includes a control unit 21 that controls each component of the image forming apparatus 1. The image forming unit 1B further includes an image processing unit 22. The image processing unit 22 processes image data received from a device such as an image reading device 4 or a personal computer (PC) 5. In addition, the image forming unit 1B is provided with a user interface (UI) 23 that is formed of a touch panel or the like, notifies a user of information, and receives input of information from the user.

The image forming section 20 as an example of an image forming means includes six image forming units 30T, 30P, 30Y, 30M, 30C, and 30K (hereinafter, the image forming units may be simply referred to as “image forming units 30”) arranged in parallel at regular intervals. Each of the image forming units 30 includes a photosensitive drum 31 on which an electrostatic latent image is formed while the photosensitive drum 31 rotates in the direction of arrow A, a charging roll 32 that charges a surface of the photosensitive drum 31, a developer 33 that develops the electrostatic latent image formed on the photosensitive drum 31, and a drum cleaner 34 that removes toner and the like from the surface of the photosensitive drum 31.

Further, the image forming section 20 is provided with an exposure device 26 for exposing the photosensitive drums 31 of the image forming units 30 to laser light. The exposure of the photosensitive drums 31 by the exposure device 26 is not limited to exposure using the laser light. For example, a light source such as a light emitting diode (LED) may be provided for each of the image forming units 30, and the photosensitive drums 31 may be exposed to light emitted from the light sources.

The image forming units 30 are configured similarly, except for toner stored in the developers 33. The image forming units 30Y, 30M, 30C, and 30K form toner images of yellow (Y), magenta (M), cyan (C), and black (K), respectively. The image forming units 30T and 30P form toner images using a toner corresponding to a corporate color, a foaming toner for Braille, a fluorescent color toner, a toner for improving glossiness, or the like. In other words, the image forming units 30T and 30P form the toner images using a special toner.

Furthermore, the image forming section 20 is provided with an intermediate transfer belt 41 onto which the toner images of the respective colors formed on the photosensitive drums 31 of the respective image forming units 30 are transferred. In addition, the image forming section 20 is provided with primary transfer rolls 42 that transfer the color toner images formed by the image forming units 30 onto the intermediate transfer belt 41 at primary transfer portions T1. The image forming section 20 includes a secondary transfer roll 40 that collectively transfers the toner images transferred onto the intermediate transfer belt 41 onto the sheet P at a secondary transfer section T2. Furthermore, the image forming section 20 includes a belt cleaner 45 that removes toner and the like on a surface of the intermediate transfer belt 41, and a fixer 80 that fixes the secondarily transferred images onto the sheet P.

The image forming section 20 performs an image forming operation based on a control signal from the control unit 21. To be specific, in the image forming section 20, first, the image processing unit 22 performs image processing on the image data input from the image reading device 4 or the PC 5, and the image data subjected to the image processing is supplied to the exposure device 26. Next, for example, in the image forming unit 30M for magenta (M), the surface of the photosensitive drum 31 is charged by the charging roll 32, and then the photosensitive drum 31 is irradiated by the exposure devices 26 with laser light modulated with the image data obtained from the image processing unit 22.

Thus, an electrostatic latent image is formed on the photosensitive drum 31. The formed electrostatic latent image is developed by the developer 33, and a magenta toner image is formed on the photosensitive drum 31. Similarly, yellow, cyan, and black toner images are formed in the image forming units 30Y, 30C, and 30K, and special color toner images are formed in the image forming units 30T and 30P.

The toner images of the respective colors formed by the image forming units 30 are sequentially electrostatically transferred by the primary transfer rolls 42 onto the intermediate transfer belt 41 rotating in the direction of arrow C in FIG. 1, and the superimposed toner images are formed on the intermediate transfer belt 41. The superimposed toner images formed on the intermediate transfer belt 41 are conveyed to a secondary transfer section T2 formed by the secondary transfer roll 40 and a backup roll 49 as the intermediate transfer belt 41 is moved.

On the other hand, the sheet P is, for example, taken out by the feed roll 15 from the first sheet storage portion 11, and then conveyed to the position of a registration roll 74 via the conveyance path. When the superimposed toner images are conveyed to the secondary transfer section T2, the sheet P is supplied from the registration roll 74 to the secondary transfer portion T2 in accordance with the timing of conveying the superimposed toner images to the secondary transfer section T2. Then, in the secondary transfer section T2, the superimposed toner images are collectively electrostatically transferred onto the sheet P by the action of a transfer electric field formed between the secondary transfer roll 40 and the backup roll 49.

Thereafter, the sheet P onto which the superimposed toner images have been electrostatically transferred is conveyed to the fixer 80. The superimposed toner images are unfixed toner images before a fixing process is performed by the fixer 80. At the fixer 80, the sheet P on which the unfixed toner images are formed is pressurized and heated, and the fixing process of fixing the toner images onto the sheet P is performed. Then, the sheet P on which the fixing process has been performed is conveyed to a sheet stacking section (not illustrated) after passing through a curl correction section 81 disposed in the sheet discharge unit 1C.

### <Configuration of Fixer 80>

During the fixing process, a part of the toner forming the unfixed toner images on the sheet P, wax contained in the toner, and the like adhere to the fixer 80. The fixer 80 according to the present exemplary embodiment includes a cleaning means for removing the adhering toner, wax, and the like. The fixer 80 will be described below with reference to some configuration examples. The fixer 80 is an example of a fixing device.

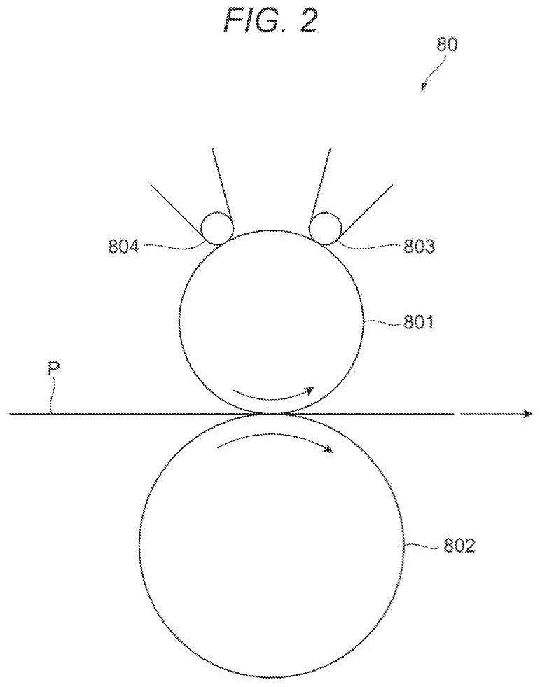

FIG. 2 is a diagram schematically illustrating a configuration of the fixer 80. The fixer 80 includes a heating roll 801 and a pressure roll 802 that pressurize and heat the sheet P on which the unfixed toner images have been formed, with the sheet P interposed between the heating roll 801 and the pressure roll 802. The heating roll 801 includes a heat source (not illustrated), and heats the sheet P while rotating with a surface (circumferential surface) of the heating roller 801 being in contact with a surface of the sheet P on which the unfixed toner images have been formed. The pressure roll 802 is disposed to face the heating roll 801, and sandwiches and pressurizes the sheet P together with the heating roll 801.

Furthermore, the fixer 80 includes a first cleaning section and a second cleaning section for cleaning the heating roll 801. Since the heating roll 801 comes into contact with the surface of the sheet P on which the unfixed toner images have been formed in the fixing process, a part of the toner forming the unfixed toner images adheres to the surface of the heating roll 801. Furthermore, the toner contains wax for suppressing adhesion of the toner to the heating roll 801, but a part of the wax also adheres to the surface of the heating roll 801. The first cleaning section 803 removes the toner and foreign matter having substantially the same size as the toner adhering to the heating roll 801. The second cleaning section 804 removes the wax adhering to the heating roll 801. That is, the first cleaning section 803 removes relatively large particles, such as toner, from the heating roll 801. On the other hand, the second cleaning section 804 removes particles that form the wax and are smaller than those of the toner and the like.

In the fixer 80 illustrated in FIG. 2, when the fixing process is performed, the sheet P moves from left to right between the heating roll 801 and the pressure roll 802. In addition, in the same drawing, the heating roll 801 rotates counterclockwise, and the pressure roll 802 rotates clockwise. In this case, the first cleaning section 803 that removes larger particles is disposed upstream of the second cleaning section 804 that removes smaller particles in a rotation direction of the heating roll 801. Therefore, in FIG. 2, the first cleaning section 803 is arranged on the right side and the second cleaning section 804 is arranged on the left side.

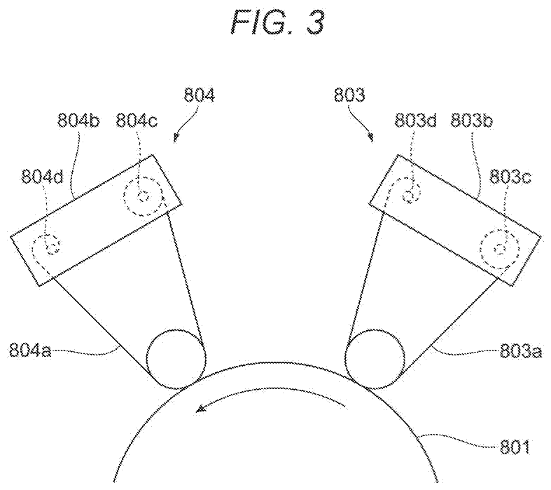

FIG. 3 is a diagram illustrating an example of a configuration of the first cleaning section 803 and the second cleaning section 804. The first cleaning section 803 includes a web member 803a that contacts the heating roll 801 and a feed mechanism 803b that feeds the web member 803a such that an unused portion of the web member 803a contacts the heating roll 801. As the web member 803a of the first cleaning section 803 that removes large particles, a member with a rougher surface than a surface of a web member 804a of the second cleaning section 804 that removes small particles may be used. Specifically, for example, a sheet material or the like made of aramid fiber is used.

The feed mechanism 803b includes an unwinding section 803c that holds a roll of the web member 803a and feeds the web member 803a, and a winding section 803d that winds the web member 803a that has been fed from the unwinding section 803c and has cleaned the heating roll 801. The unwinding section 803c and the winding section 803d feed the web member 803a at a predetermined speed. Thus, an unused portion of the web member 803a comes into contact with the heating roll 801 to remove foreign matter such as the toner adhering to the surface of the heating roll 801.

The operation of feeding the web member 803a by the feed mechanism 803b may be interlocked with the operation of the fixer 80, and the operation of feeding the web member 803a may be performed only when image forming is performed and the fixer 80 is operated. The operation of feeding the web member 803a may be continuously performed by the feed mechanism 803b at a constant speed, or may be intermittently performed to feed the web member 803a by a predetermined amount every time the heating roll 801 rotates by a constant amount.

The second cleaning section 804 includes the web member 804a that contacts the surface of the heating roll 801 and a feed mechanism 804b that feeds the web member 804a such that an unused portion of the web member 804a contacts the heating roll 801. The web member 804a of the second cleaning section 804 for removing small particles may be a member having a smoother surface than the surface of the web member 803a of the first cleaning section 803 for removing large particles. Specifically, for example, a sheet material or the like made of fluororesin is used.

The feed mechanism 804b includes an unwinding section 804c that holds a roll of the web member 804a and feeds the web member 804a, and a winding section 804d that winds the web member 804a that has been fed from the unwinding section 804c and has cleaned the heating roll 801. The unwinding section 804c and the winding section 804d feed the web member 804a at a predetermined speed. Thus, an unused portion of the web member 804a comes into contact with the heating roll 801 to remove the wax adhering to the surface of the heating roll 801. The operation of feeding the web member 804a by the feed mechanism 804b may be interlocked with the operation of the fixer 80, and the operation of feeding the web member 804a may be performed only when the image forming is performed and the fixer 80 is operated. The operation of feeding the web member 804a may be continuously performed by the feed mechanism 804b at a constant speed, or may be intermittently performed to feed the web member 804a by a predetermined amount every time the heating roll 801 rotates by a constant amount.

In this case, a speed at which the web member 804a is fed by the feed mechanism 804b of the second cleaning section 804 may be lower than a speed at which the web member 803a is fed by the feed mechanism 803b of the first cleaning section 803. This is because the wax adhering to the heating roll 801 is also removed to some extent together with the toner by the cleaning using the first cleaning section 803, and therefore, a degree of progress of contamination on the web member 804a of the second cleaning section 804 is smaller than that on the web member 803a of the first cleaning section 803. By reducing the speed at which the web member 804a of the second cleaning section 804 is fed, the consumption of the web member 804a of the second cleaning section 804 is reduced, and the cost is reduced. When the operation of feeding the web members 803a and 804a by the feed mechanisms 803b and 804b of the first cleaning section 803 and the second cleaning section 804 is intermittently performed, a configuration may be adopted in which every time the feed mechanism 803b of the first cleaning section 803 feeds the web member 803a a fixed number of times, the feed mechanism 804b of the second cleaning section 804 feeds the web member 804a once.

More preferably, the speed at which the web member 804a is fed by the feed mechanism 804b of the second cleaning section 804 may be an integer fraction of the speed at which the web member 803a is fed by the feed mechanism 803b of the first cleaning section 803. In this case, a time required for the web member 804a of the second cleaning section 804 to be consumed and replaced is an integer multiple of a time required for the web member 803a of the first cleaning section 803 to be consumed and replaced. That is, while the replacement of the web member 804a of the second cleaning section 804 is performed once, the replacement of the web member 803a of the first cleaning section 803 is performed a plurality of times. At the timing of replacing the web member 804a of the second cleaning section 804, the replacement of the web member 803a of the first cleaning section 803 is also performed together. Therefore, time and effort required for replacing the web members 803a and 804a are reduced.

### <Other Examples of Configuration of Fixer 80>

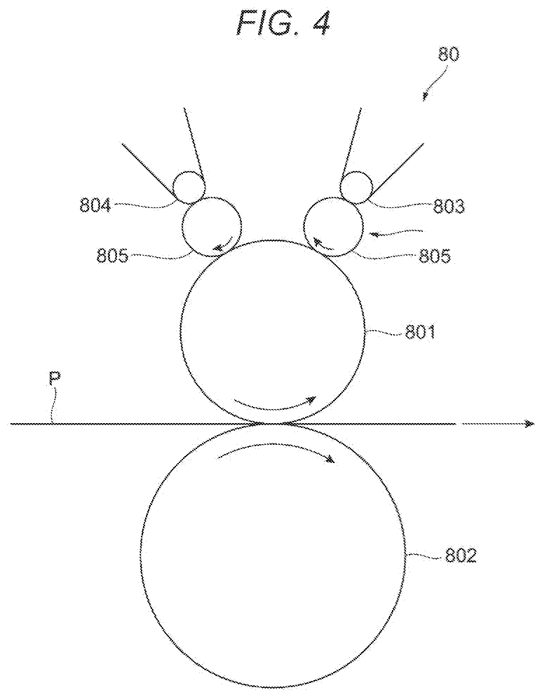

FIG. 4 is a diagram illustrating another example of the configuration of the fixer 80. A fixer 80 illustrated in FIG. 4 includes an external heating roll 805 that heats a heating roll 801, in addition to the heating roll 801 and a pressure roll 802. The heating roll 801 and the pressure roll 802 are the same as the heating roll 801 and the pressure roll 802 of the fixer 80 described with reference to FIG. 2, and thus description thereof is omitted. In the fixer 80 illustrated in FIG. 4, a first cleaning section 803 and a second cleaning section 804 are disposed in contact with the external heating roll 805.

The external heating roll 805 is an example of an external heating device that externally heats the heating roll 801. In the image forming apparatus 1 that forms an image at a high speed, a fixing process is performed by the fixer 80 at a high speed. Thus, the amount of the sheet P contacting the heating roll 801 per unit time increases, and thus the heat of the heating roll 801 is taken by the sheet P and a degree of lowering of the temperature of the heating roll 801 is large. Therefore, a configuration is adopted in which a decrease in the temperature of the heating roll 801 is suppressed by heating the surface of the heating roll 801 with the external heating roll 805. The external heating roll 805 includes a heat source (not shown), and a plurality of external heating rolls 805 are provided in the configuration illustrated in FIG. 4. Although two external heating rolls 805 are provided in the illustrated example, three or more external heating rolls 805 may be provided. In the fixer 80 including the external heating roll 805, a configuration in which the heating roll 801 itself also includes a heat source may be adopted, or a configuration in which the heating roll 801 does not have a heat source and is heated by only the external heating roll 805 may be adopted. As the external heating roll 805, an existing configuration can be used.

Since the external heating roll 805 is in contact with the surface of the heating roll 801, toner and wax adhering to the heating roll 801 are transferred onto the external heating roll 805 in a process in which the external heating roll 805 heats the heating roll 801. Therefore, in the fixer 80 illustrated in FIG. 4, the toner and the wax transferred onto the external heating roll 805 are removed by the first cleaning section 803 and the second cleaning section 804. In the configuration illustrated in FIG. 4, a part of foreign matter such as the toner and the wax is transferred onto the external heating roll 805 on the upstream side (right side in the drawing) in a rotation direction of the heating roll 801 out of the two external heating rolls 805. Therefore, the first cleaning section 803 is disposed in contact with the external heating roll 805 on the upstream side. Furthermore, the wax that has not been transferred onto the external heating roll 805 on the upstream side and remains is transferred onto the external heating roll 805 on the downstream side (left side in the drawing) in the rotation direction of the heating roll 801. Therefore, the second cleaning section 804 is disposed in contact with the external heating roll 805 on the downstream side.

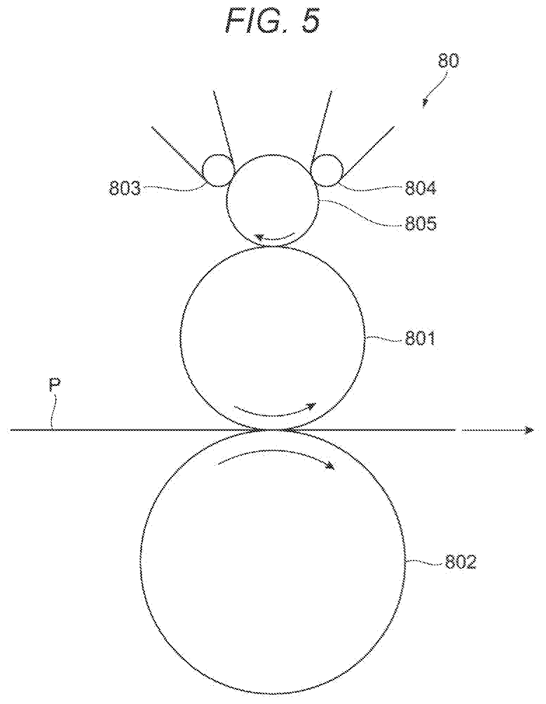

FIG. 5 is a diagram illustrating a modification of the fixer 80 illustrated in FIG. 4. A fixer 80 illustrated in FIG. 5 includes a heating roll 801, a pressure roll 802, and one external heating roll 805. The heating roll 801 and the pressure roll 802 are the same as the heating roll 801 and the pressure roll 802 of the fixer 80 described with reference to FIG. 2, and thus description thereof is omitted. In the fixer 80 illustrated in FIG. 5, both of a first cleaning section 803 and a second cleaning section 804 are provided in contact with the one external heating roll 805.

In the configuration illustrated in FIG. 5, foreign matter such as toner and wax transferred from the heating roll 801 onto the external heating roll 805 is removed by the first cleaning section 803 and the second cleaning section 804. The external heating roll 805 has a surface (circumferential surface) in contact with a surface of the heating roll 801, and heats the surface of the heating roll 801 while rotating. Therefore, as indicated by arrows in FIG. 5, a rotation direction of the external heating roll 805 and a rotation direction of the heating roll 801 are opposite directions. The first cleaning section 803 is provided on the upstream side in the rotation direction of the external heating roll 805, and the second cleaning section 804 is provided on the downstream side in the rotation direction of the external heating roll 805. Therefore, in FIG. 5, the first cleaning section 803 is arranged on the left side and the second cleaning section 804 is arranged on the right side.

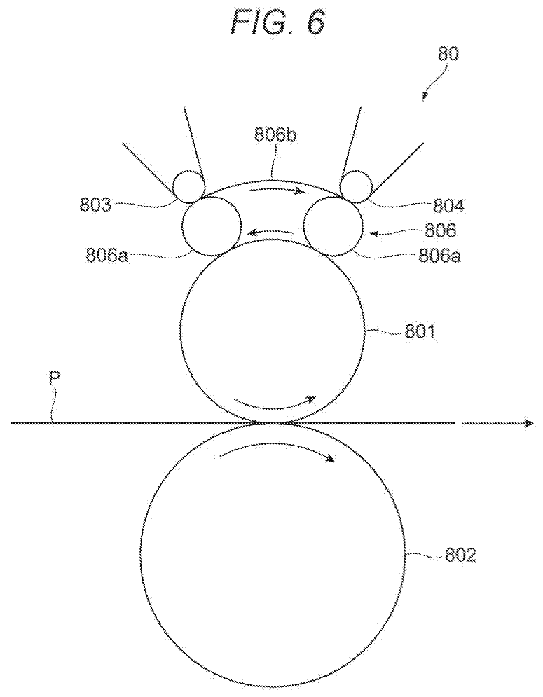

FIG. 6 is a view illustrating another example of the configuration of the fixer 80 having the external heating device. A fixer 80 illustrated in FIG. 6 includes an external heating belt 806 that heats a heating roll 801, in addition to the heating roll 801 and a pressure roll 802. The heating roll 801 and the pressure roll 802 are the same as the heating roll 801 and the pressure roll 802 of the fixer 80 described with reference to FIG. 2, and thus description thereof is omitted. In the fixer 80 illustrated in FIG. 6, a first cleaning section 803 and a second cleaning section 804 are disposed in contact with the external heating belt 806.

The external heating belt 806 is an example of the external heating device. The external heating belt 806 includes two support rolls 806a and a belt member 806b stretched over the support rolls 806a. The support rolls 806a have a heat source (not illustrated) and heat the belt member 806b while supporting the belt member 806b. A portion (lower portion in FIG. 6) of the belt member 806b stretched between the two support rolls 806a is disposed in contact with a surface of the heating roll 801. The belt member 806b is formed of a member having high thermal conductivity, is heated by the support rolls 806a, and heats the heating roll 801 at a portion contacting the heating roll 801.

Since the belt member 806b of the external heating belt 806 is in contact with the surface of the heating roll 801, toner and wax adhering to the heating roll 801 are transferred onto the belt member 806b in a process in which the external heating belt 806 heats the heating roll 801. Therefore, in the fixer 80 illustrated in FIG. 6, the toner and the wax transferred onto the belt member 806b of the external heating belt 806 are removed by the first cleaning section 803 and the second cleaning section 804. The belt member 806b is stretched over the two support rolls 806a and heats the surface of the heating roll 801 while rotating in contact with the heating roll 801. Therefore, as indicated by arrows in FIG. 6, a rotation direction of the belt member 806b and a rotation direction of the heating roll 801 are opposite directions. The first cleaning section 803 is provided on the upstream side in the rotation direction of the belt member 806b, and the second cleaning section 804 is provided on the downstream side in the rotation direction of the belt member 806b. Therefore, in FIG. 6, the first cleaning section 803 is arranged on the left side, and the second cleaning section 804 is arranged on the right side.

In each of the configuration examples described above with reference to FIGS. 4 to 6, in the fixer 80 having the external heating device, both the first cleaning section 803 and the second cleaning section 804 are configured to remove toner and wax transferred onto the external heating device. Accordingly, it is possible to suppress deterioration or damage of the surface of the heating roll 801 due to direct contact of the web members 803a and 804a of the first cleaning section 803 and the second cleaning section 804 with the heating roll 801. On the other hand, if the deterioration or damage of the surface of the heating roll 801 can be reduced depending on the material of the surface of the heating roll 801, the material of the web members 803a and 804a, or the like, one of the first cleaning section 803 and the second cleaning section 804 may be configured to remove toner or wax adhering to the heating roll 801. Furthermore, regardless of the presence or absence of an external heating device, as in the fixer 80 described with reference to FIG. 2, both the first cleaning section 803 and the second cleaning section 804 may be configured to remove toner or wax adhering to the heating roll 801.

Although the exemplary embodiments of the present invention have been described above, the technical scope of the present invention is not limited to the above-described exemplary embodiments. For example, in the above-described exemplary embodiments, the web member 803a of the first cleaning section 803 and the web member 804a of the second cleaning section 804 are formed of different members, but the web member 803a and the web member 804a may be formed of the same member as long as toner and foreign matter can be removed by the first cleaning section 803 and wax can be removed by the second cleaning section 804. In addition, various changes and configuration alternatives that do not depart from the scope of the technical idea of the present invention are included in the present invention.

### SUPPLEMENTARY NOTES

(((1)))

A fixing device comprising:
a heating roll that heats a recording medium having a toner image formed on the recording medium while rotating in contact with the recording medium;
a pressure roll that sandwiches the recording medium with the heating roll to pressurize the recording medium;
a first cleaning section that removes toner adhering to the heating roll; and
a second cleaning section that is located downstream of the first cleaning section in a rotation direction of the heating roll and removes wax adhering to the heating roll.
   (((2)))

The fixing device according to (((1))), wherein
each of the first cleaning section and the second cleaning section includes a web member that contacts the heating roll, and a feed mechanism that feeds the web member such that an unused portion of the web member contacts the heating roll.

(((3)))

The fixing device according to (((2))), wherein
the web member of the second cleaning section is made of a material having a surface smoother than a surface of the web member of the first cleaning section.
   (((4)))

The fixing device according to (((2))) or (((3))), wherein
a speed at which the web member of the second cleaning section is fed is lower than a speed at which the web member of the first cleaning section is fed.
   (((5)))

The fixing device according to any one of (((2))) to (((4))), wherein
the speed at which the web member of the second cleaning section is fed is an integer fraction of the speed at which the web member of the first cleaning section is fed.
   (((6)))

The fixing device according to any one of (((1))) to (((5))), further comprising
an external heating device that heats the heating roll,
wherein the first cleaning section removes toner transferred from the heating roll onto the external heating device, and the second cleaning section removes wax transferred from the heating roll onto the external heating device.
   (((7)))

The fixing device according to (((6))), wherein
in a case where the fixing device includes a plurality of external heating devices identical to the external heating device, the first cleaning section removes toner from the external heating device on an upstream side in the rotation direction of the heating roll, and the second cleaning section removes wax from the external heating device on a downstream side in the rotation direction of the heating roll.
   (((8)))

An image forming apparatus comprising the fixing device according to any one of (((1))) to (((7))).

What is claimed is:

1. A fixing device comprising:
a heating roll that heats a recording medium having a toner image formed on the recording medium while rotating in contact with the recording medium;
a pressure roll that sandwiches the recording medium with the heating roll to pressurize the recording medium;
a first cleaning section that removes toner adhering to the heating roll; and
a second cleaning section that is located downstream of the first cleaning section in a rotation direction of the heating roll and removes wax adhering to the heating roll.

2. The fixing device according to claim 1, wherein
each of the first cleaning section and the second cleaning section includes a web member that contacts the heating roll, and a feed mechanism that feeds the web member such that an unused portion of the web member contacts the heating roll.

3. The fixing device according to claim 2, wherein
the web member of the second cleaning section is made of a material having a surface smoother than a surface of the web member of the first cleaning section.

4. The fixing device according to claim 2, wherein
a speed at which the web member of the second cleaning section is fed is lower than a speed at which the web member of the first cleaning section is fed.

5. The fixing device according to claim 4, wherein
the speed at which the web member of the second cleaning section is fed is an integer fraction of the speed at which the web member of the first cleaning section is fed.

6. The fixing device according to claim 1, further comprising
an external heating device that heats the heating roll,
wherein the first cleaning section removes toner transferred from the heating roll onto the external heating device, and the second cleaning section removes wax transferred from the heating roll onto the external heating device.

7. The fixing device according to claim 6, wherein
in a case where the fixing device includes a plurality of external heating devices identical to the external heating device, the first cleaning section removes toner from the external heating device on an upstream side in the rotation direction of the heating roll, and the second cleaning section removes wax from the external heating device on a downstream side in the rotation direction of the heating roll.

8. An image forming apparatus comprising the fixing device according to claim 1.

9. An image forming apparatus comprising the fixing device according to claim 2.

10. An image forming apparatus comprising the fixing device according to claim 3.

11. An image forming apparatus comprising the fixing device according to claim 4.

12. An image forming apparatus comprising the fixing device according to claim 5.

13. An image forming apparatus comprising the fixing device according to claim 6.

14. An image forming apparatus comprising the fixing device according to claim 7.
